(19) United States
(12) Patent Application Publication
(10) Pub. No.: US 2006/0085805 A1
(43) Pub. Date: Apr. 20, 2006

(54) Optical disk drive

(75) Inventor: Chin-Wen Yang, Taoyuan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/242,055

(22) Filed: Oct. 4, 2005

(30) Foreign Application Priority Data
Oct. 18, 2004 (TW) 93131585

(51) Int. Cl. G11B 17/04

(52) U.S. Cl. 720/619

(57) ABSTRACT

An optical disk drive is disclosed. The optical disk drive for operating an optical disk which is bi-directionally transported along a center axis of the optical disk drive includes a shield, a tray and a holder. The tray is movably connected to the shield. The holder pivots on the tray to form a cantilever with a free end. A space is defined between the free end and the center axis, and the optical disk is clamped between the tray and the holder.

### BACKGROUND

The invention relates to an optical disk drive, and in particular to an optical disk drive with a clamp holder.

FIG. 1A depicts a conventional optical disk drive. The optical disk 10 enters the shield 11 through the opening 111. FIG. 1B depicts a holding mechanism 13 in the shield 11 of the conventional optical disk drive. The holding mechanism 13 clamps the optical disk 10 as it moves into the shield 11. The holding mechanism 13 comprises an upper cover 131, a clamping plate 132, a lower cover 133 and a torsion spring 134. The upper and lower covers 131 and 133 are engaged by screws (not shown) passing through the threaded holes 135. The clamping plate 132 is disposed on the shaft 136 between the upper and lower covers 131 and 133 and rotates thereby. The torsion spring 134 disposed between the upper cover 131 and the shaft 136 provides a force on the clamping plate 132 to secure the optical disk 10 in place. FIG. 1C depicts the optical disk 10 disposed in the shield 11 and held in place by the lateral A of the clamping plate 132 shown in FIG. 1B. The roller 137 at the bottom of the holding mechanism 13 slides along the track 122 on the inner surface of the shield 11 until the pickup mechanism 12, the turntable 14, and the optical disk 10 are aligned with each other. Furthermore, a drop zone 113 is formed on the track 112 due to the required vertical movement of the holding mechanism 13 along the track 112 in order to prevent interference with the spindle 121.

The conventional optical disk drive has a complicated inner structure, a great number of components, large volume, and low reliability, thus an optical disk drive capable of ameliorating the described disadvantages is desirable.

### SUMMARY

The invention discloses an optical disk drive. The optical disk drive for operating an optical disk which is bi-directionally transported along a center axis of the optical disk drive includes a shield, a tray and a holder. The tray is movably connected to the shield. The holder pivots on the tray to form a cantilever with a free end. A space is defined between the free end and the center axis, and the optical disk is clamped between the tray and the holder.

The optical disk drive may further comprise a pickup mechanism connected to the shield, moving along the center axis with respect to the tray and the holder, passing through the space.

The holder may comprise a shaft pivoted on the tray. The tray may comprise a connection portion projecting upward therefrom. The shaft of the holder pivots on the connection portion.

The optical disk drive may further comprise a resilient member disposed between the tray and the shaft, providing a force to the holder to secure the optical disk in place. The resilient member may comprise a torsion spring.

The optical disk drive may further comprise a protrusion protruding toward the tray. The holder may comprise an actuating portion. When the tray moves to a position with respect to the shield, the protrusion abuts the actuating portion, and the holder rotates via the shaft, releasing the optical disk.

The optical disk drive may further comprise a damper disposed on the tray, and the optical disk is clamped between the holder and the damper.

The holder may be parallel to a surface of the tray and project toward the center axis.

Accordingly, an extension direction of the holder may be perpendicular to the center axis.

The invention further discloses an optical disk drive. The optical disk drive for operating an optical disk which is bi-directionally transported along a center axis of the optical disk drive comprises a shield, a tray, and two holders. The tray is connected to the shield and movable between a first position and a second position. The holders are symmetrically disposed on the tray and project toward the center axis. The optical disk is clamped between the tray and the holders.

The holders may be parallel to the tray. Each holder is a cantilever with a free end, and a space is defined between the free ends.

The optical disk drive may further comprise a pickup mechanism connected to the shield, moving along the center axis with respect to the tray and the holders, passing through the space.

Each holder may comprise a shaft pivoted on the tray. The tray may comprise two connection portions symmetrically arranged according to the center axis and projecting upward from a surface of the tray. The shafts of the holders are pivoted on the connection portions.

The optical disk drive may further comprise two resilient members disposed between the tray and the shafts, providing a force to the holders to secure the optical disk in place. The resilient members may be torsion springs.

The optical disk drive may further comprise two protrusions protruding toward the tray. Each holder may comprise an actuating portion. When the tray moves to the second position, the protrusions abut the actuating portions, and the holders rotate via the shafts, releasing the optical disk.

The optical disk drive may further comprise two dampers disposed on the tray, and the optical disk is clamped between the holders and the dampers.

Accordingly, an extension direction of the holders may be perpendicular to the center axis.

### DESCRIPTION OF THE DRAWINGS

The invention can be more fully understood by reading the subsequent detailed description in conjunction with the examples and references made to the accompanying drawings, wherein:

FIG. 1A is a schematic view of a conventional optical disk drive;

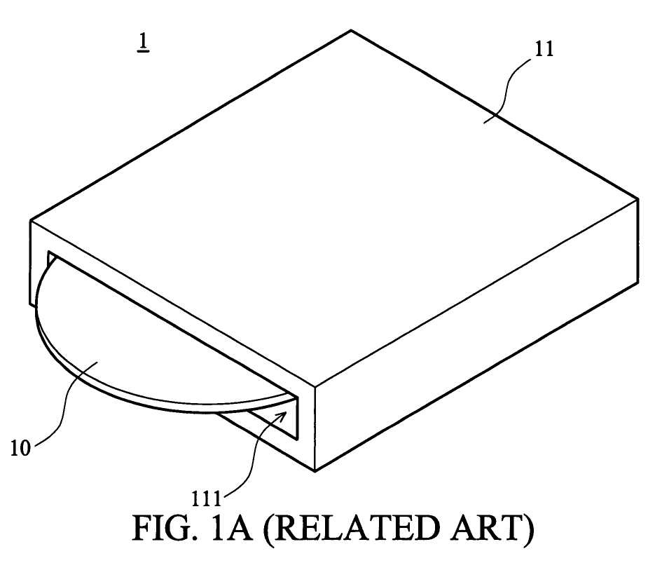

FIG. 1B is a partially enlarged view of a conventional optical disk drive;

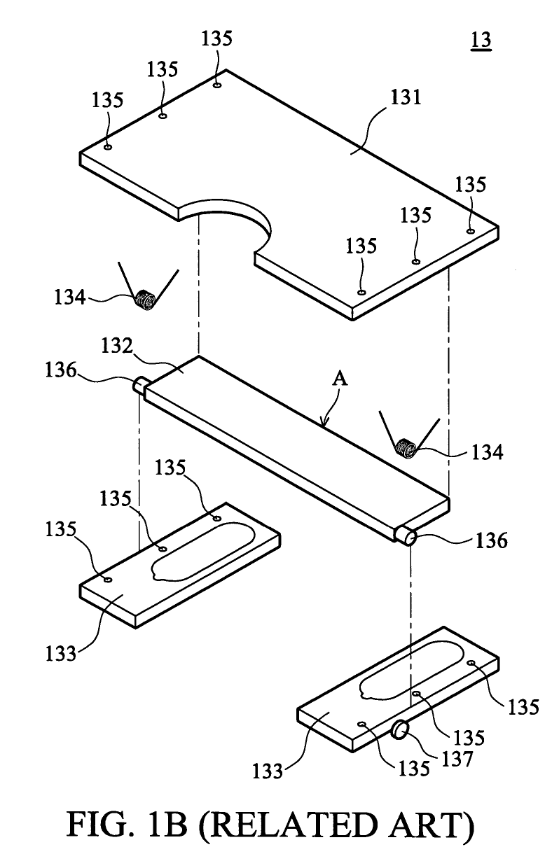

FIG. 1C is another partially enlarged view of a conventional optical disk drive;

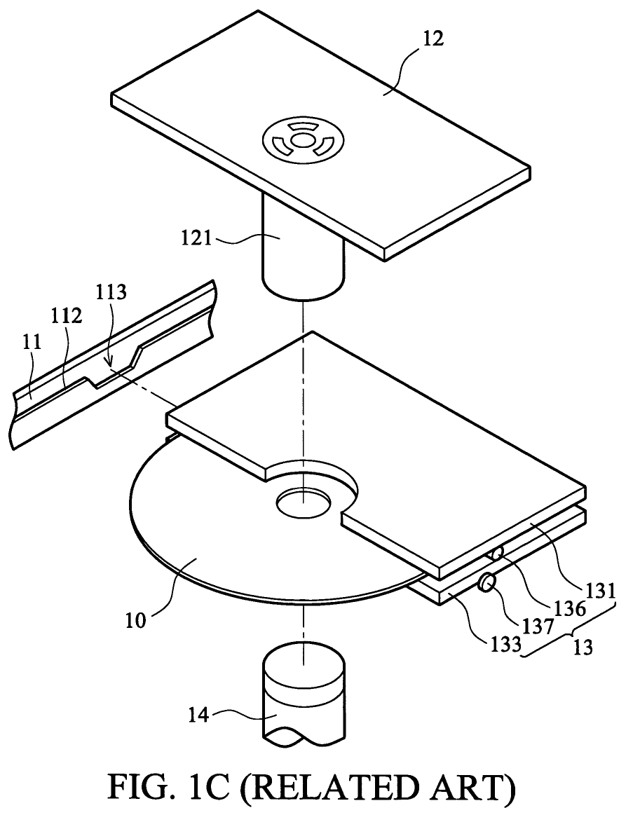

FIG. 2A is a schematic view of an optical disk drive of the invention;

FIG. 2B is another schematic view of an optical disk drive of the invention;

FIG. 3A is a partially enlarged view of an optical disk drive of the invention;

FIG. 3B is a partially enlarged view of an optical disk drive of the invention;

FIG. 3C is a partial schematic view of an optical disk drive of the invention;

FIG. 4A is a partially enlarged view of an optical disk drive of the invention;

FIG. 4B is a partially enlarged view of an optical disk drive of the invention.

### DETAILED DESCRIPTION

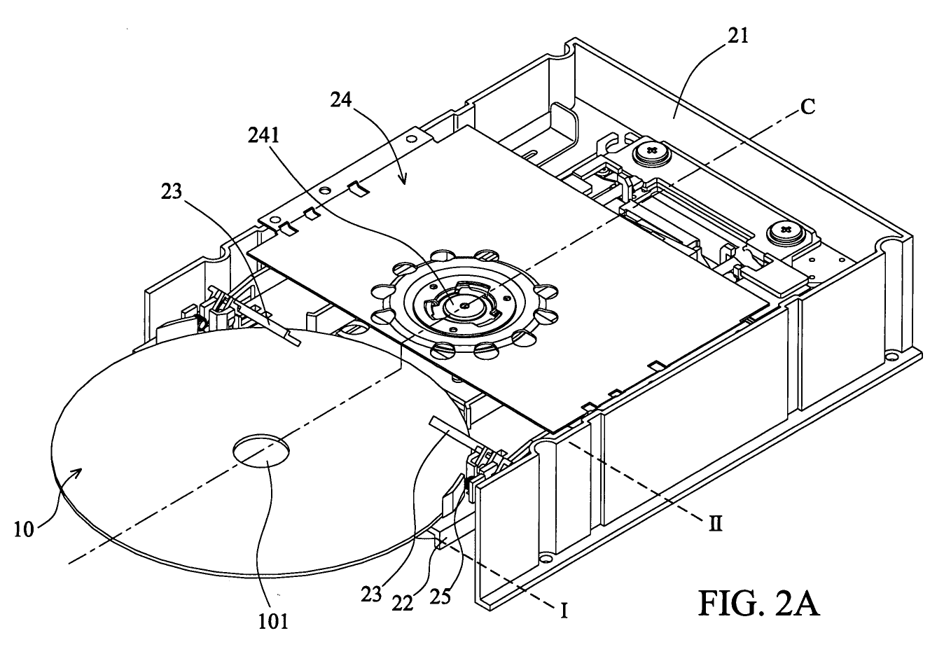

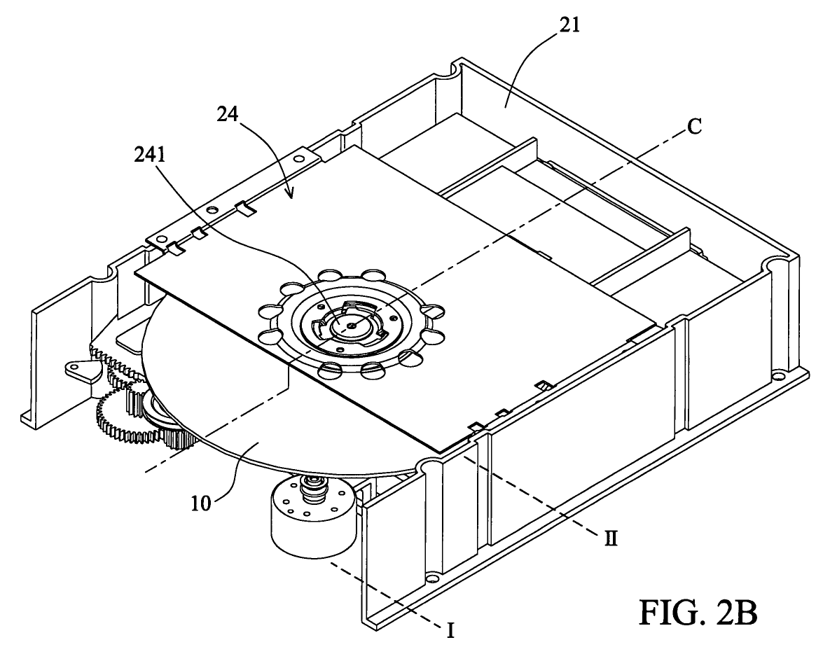

FIGS. 2A and 2B depict an optical disk drive of the invention comprising a shield 21, a tray 22, holders 23, a pickup mechanism 24 and resilient members 25. The tray 22 is disposed in the shield 21 and movable between a first position I and a second position II.

FIG. 2A depicts the state of the front edge of the tray 22 at the first position I and FIG. 2B depicts the state of the front edge of the tray 22 at the second position II (hereinafter, simply referred to as the tray 22 at the first position I or the second position II). The optical disk 10 is placed on the tray 22 and clamped by the holders 23 as the optical disk 10 enters the optical disk drive along a center axis C, driven by a driving mechanism (not shown, such as a motor) so that the tray 22 moves from the first position I to the second position II, and the optical disk is finally received in the optical disk drive.

When the tray 22 locates at the second position II, the center hole 101 of the optical disk 10 is aligned with the spindle 241 of the pickup mechanism 24, and the holder 23 release the optical disk 10. Thereafter, the optical disk drive may read and/or write information on the optical disk 10.

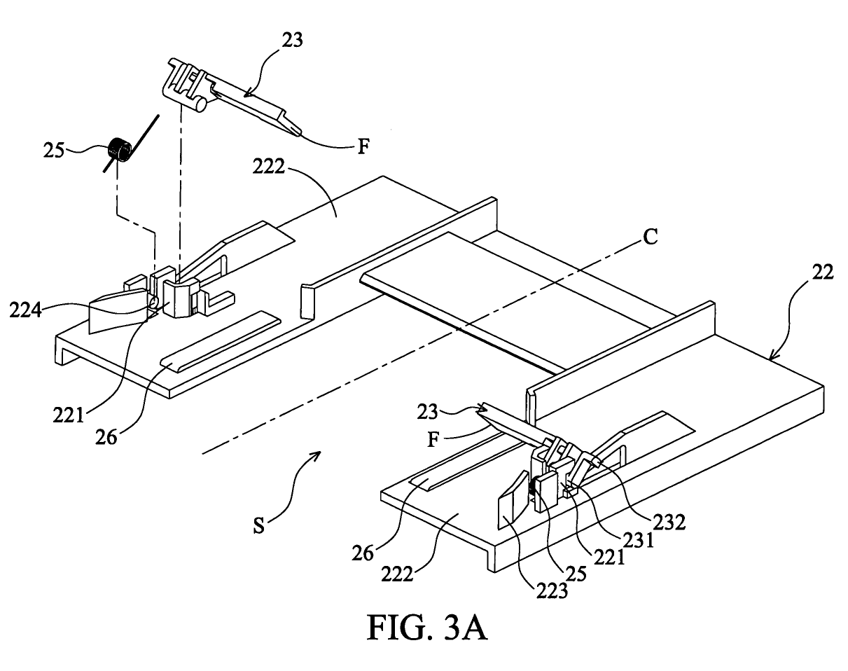

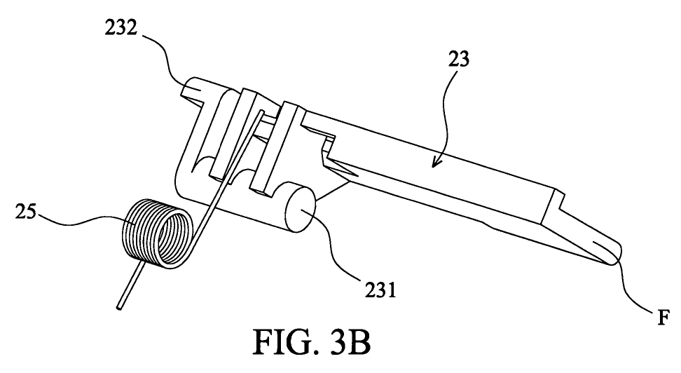

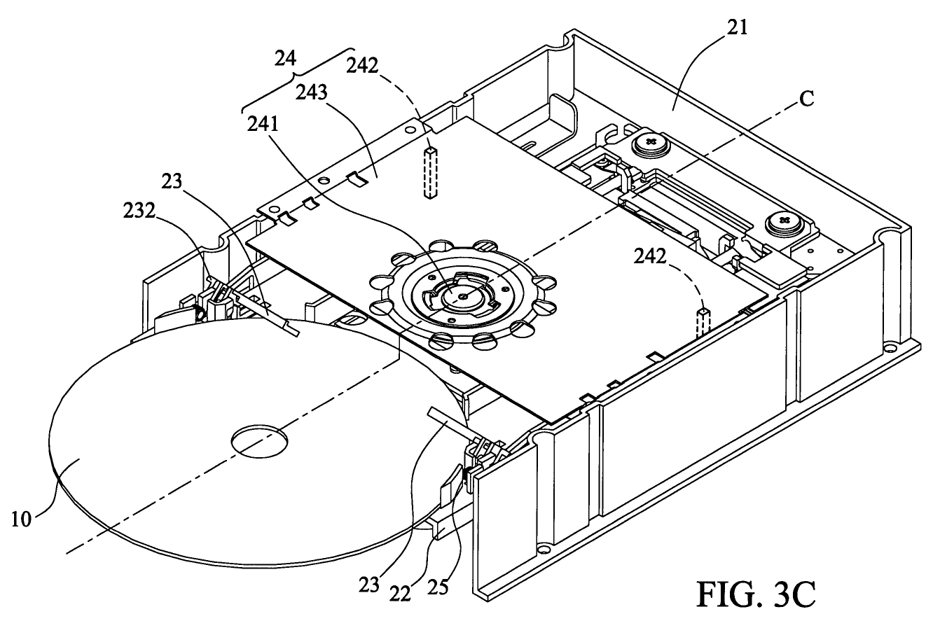

FIGS. 3A to 3C illustrate the structure of the tray 22, the holder 23, the pickup mechanism 24, and the resilient member 25.

FIG. 3A depicts the tray 22 comprising two connection portion 221 symmetrically disposed thereon with respect to the center axis C and projecting upward from a surface 222. Blocks 223 are disposed on the tray 22 to limit the optical disk 10. Further, the optical disk 10 is clamped between the plastic dampers 26 which are disposed on the tray 22 and the holders 23 to protect the optical disk 10 from scraping.

FIG. 3B depicts the holder 23, comprising a shaft 231, by which the holder 23 is pivoted to the connection portion 221, thus, the holder 23 forms a cantilever with a free end F. A space S is defined between the free end F and the center axis C. Additionally, the extension direction of the holder 23 is parallel to the surface 222 of the tray 22 and perpendicular to the center axis C.

The resilient members 25 (such as a torsion spring) are respectively and symmetrically disposed on the posts 224 of the tray 22 with respect to the center axis C. One end of the resilient member 25 abuts the shaft 231 of the holder 23, and the other end abuts the tray 22 so that the resilient members 25 provide force on the holders 23 to clamp the optical disk 10.

FIG. 3C depicts the pickup mechanism 24 comprising a spindle 241, two protrusions 242 and a cover 243. The cover 243 is fixed in the shield 21. The spindle 241 and the protrusions 242 are fixed on the cover 243 and project toward the tray 22. Further, the position of the protrusions 242 correspond to the actuating portions 232 on the holders 23.

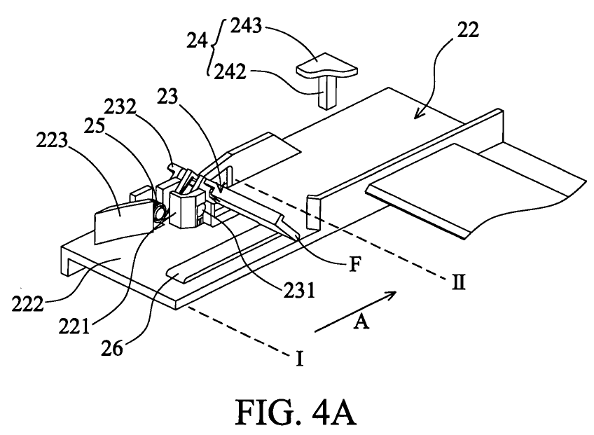

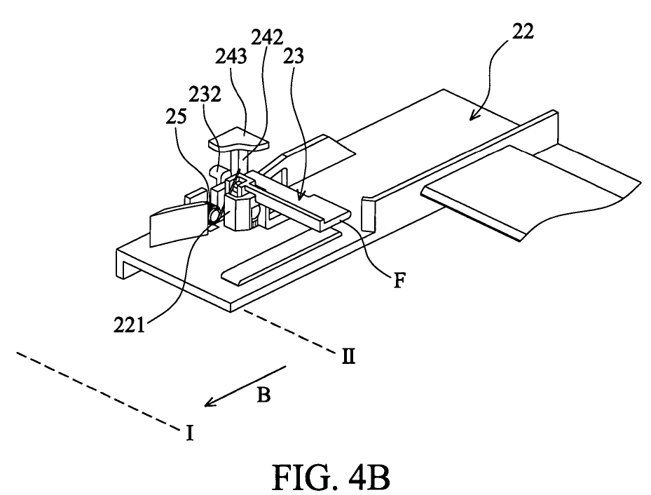

FIG. 4A depicts the tray 22 at the first position I. The holder 23 slants toward the tray 22 due to the force from the resilient member 25. Thus, when placed on the tray 22, the optical disk (not shown in FIG. 4A) is clamped between the dampers 26 and the holders 23 and limited by the blocks 223. The driving mechanism (not shown) then drives the tray 22 to move in direction A (along the center axis C) to the second position II. The space S (as shown in FIG. 3A) defined between the center axis C and the free end F allows the spindle 241 (as shown in FIG. 3C) on the cover 243 to pass through the space S without interference. FIG. 4B depicts the tray 22 in the second position II. The protrusions 242 of the pickup mechanism 24, which are always motionless, abut the actuating portions of the holders 232, which move with the tray 22, against force provided by the resilient members 25 so that the holders 23 rotate by the shafts 231, releasing the optical disk 10. Thereafter, the optical disk drive may read and/or write information on the optical disk 10.

When ejecting the optical disk, the driving mechanism drives the tray 22 to move in direction B (along the center axis C) to the first position I. Meanwhile, the tray 22 starts moving, the actuating portions 232 separate from the protrusions 242, and the holders 23 then rotate toward the tray 22 due to force provided by the resilient member 25 to again clamp the optical disk. Finally, the tray 22 moves back to the first position I as shown in FIG. 4A, ejecting the optical disk.

As mentioned, the structure of the optical disk drive of the invention is simpler, has fewer components, and reduced size. The tray, the holder and the resilient member are assembled without screws. The space is defined between the free end of the holder and the center axis, and the thickness of the tray is reduced. Thus, the tray, the holder and the optical disk are movable between the first position and the second position without interference with the pickup mechanism. In other words, the optical disk drive of the invention does not move down the tray and thus prevents interference between the tray, the holder and the pickup mechanism.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical disk drive for operating an optical disk which is bi-directionally transported along a center axis of the optical disk drive, comprising:
a shield;
a tray movably connected to the shield; and
a holder pivoted on the tray to form a cantilever with a free end, wherein a space is defined between the free end and the center axis, and the optical disk is clamped between the tray and the holder.

2. The optical disk drive as claimed in claim 1, further comprising a pickup mechanism connected to the shield, moving along the center axis with respect to the tray and the holder, passing through the space.

3. The optical disk drive as claimed in claim 1, wherein the holder comprises a shaft pivoted on the tray.

4. The optical disk drive as claimed in claim 3, wherein the tray comprises a connection portion projecting upward therefrom, and the shaft of the holder pivoted on the connection portion.

5. The optical disk drive as claimed in claim 4, further comprising a resilient member disposed between the tray and the shaft, providing a force to the holder to secure the optical disk in place.

6. The optical disk drive as claimed in claim 5, wherein the resilient member comprises a torsion spring.

7. The optical disk drive as claimed in claim 5, further comprising a protrusion protruding toward the tray, the holder comprising an actuating portion, wherein when the tray moves to a position with respect to the shield, the protrusion abuts the actuating portion, and the holder rotates via the shaft, releasing the optical disk.

8. The optical disk drive as claimed in claim 1, further comprising a damper disposed on the tray, and the optical disk clamped between the holder and the damper.

9. The optical disk drive as claimed in claim 1, wherein the holder is parallel to a surface of the tray and projects toward the center axis.

10. The optical disk drive as claimed in claim 1, wherein an extension direction of the holder is perpendicular to the center axis.

11. An optical disk drive for operating an optical disk which is bi-directionally transported along a center axis of the optical disk drive, comprising:
a shield;
a tray connected to the shield, movable between a first position and a second position; and
two holders symmetrically disposed on the tray and projecting toward the center axis, wherein the optical disk is clamped between the tray and the holders.

12. The optical disk drive as claimed in claim 1, wherein the holders are parallel to the tray, each holder is a cantilever with a free end, and a space is defined between the free ends.

13. The optical disk drive as claimed in claim 12, further comprising a pickup mechanism connected to the shield, moving along the center axis with respect to the tray and the holders, passing through the space.

14. The optical disk drive as claimed in claim 11, wherein each holder comprises a shaft pivoted on the tray.

15. The optical disk drive as claimed in claim 14, wherein the tray comprises two connection portions symmetrically arranged according to the center axis and projecting upward from a surface of the tray, and the shafts of the holders pivoted on the connection portions.

16. The optical disk drive as claimed in claim 15, further comprising two resilient members disposed between the tray and the shafts, providing a force to the holders to secure the optical disk in place.

17. The optical disk drive as claimed in claim 16, wherein the resilient members comprise torsion springs.

18. The optical disk drive as claimed in claim 16, further comprising two protrusions protruding toward the tray, each holder comprising an actuating portion, wherein when the tray moves to the second position, the protrusions abut the actuating portions, and the holders rotate via the shafts, releasing the optical disk.

19. The optical disk drive as claimed in claim 11, further comprising two dampers disposed on the tray, and the optical disk clamped between the holders and the dampers.

20. The optical disk drive as claimed in claim 11, wherein an extension direction of the holders is perpendicular to the center axis.
